(19) United States
(12) Patent Application Publication
(10) Pub. No.: US 2025/0297621 A1
(43) Pub. Date: Sep. 25, 2025

(54) CLEANING PUMP SURFACES

(71) Applicant: Saudi Arabian Oil Company, Dhahran (SA)

(72) Inventors: Chinmoy Mishra, Haradh (SA); Ahmad H. Alharbi, Alkhobar (SA)

(21) Appl. No.: 18/611,247

(22) Filed: Mar. 20, 2024

(51) Int. Cl. F04D 29/70; B05B 1/00; B08B 3/02; B08B 13/00; F04D 1/00; F04D 29/08

(52) U.S. Cl. CPC F04D 29/708; B08B 3/02; B08B 13/00; F04D 1/00; F04D 29/086; B05B 1/00; B08B 2203/027

(57) ABSTRACT

A pump cleaning assembly includes a ring assembly configured to be mounted at a seal nose coaxial with a shaft center-line of a pump shaft of a pump; a plurality of spring-loaded nozzles positioned in the ring assembly and configured to spray a pressurized liquid along the pump shaft within a pump housing of the pump; and a liquid pump fluidly coupled to the plurality of spring-loaded nozzles through a tubing assembly.

### TECHNICAL FIELD

The present disclosure describes systems and methods for cleaning one or more surfaces of a pump, such as mechanical seal faces with single or double seal arrangements.

### BACKGROUND

Pumps, often experience mechanical seal failures most of the time during start-up, after a long period of non-use, especially with applications having sluggish fluid or fluid with suspended particles. For such applications, mechanical seal faces and surrounding O-rings as part of the internal pump seal structure, especially in dirty or sluggish liquid services, can be clogged or jammed and experience failures due to the dirt accumulation inside a seal chamber during the pump's downtime. When the pump is not running, solids or dirt deposit at and around the seal faces and other surrounding internal locations can accumulate, which leads to clogging of seal parts. Such clogging can cause a limitation in the axial dynamic movement required for the pump seal, as well as an excessive shear load required for relative rotary motion between static and rotating faces at their interface. Under these conditions and upon start-up, the mechanical seal can experience damage or failure.

### SUMMARY

In an example implementation, a pump system includes a pump that includes a housing that comprises a fluid inlet and a fluid outlet; a shaft that extends through the housing and is coupled to at least one impeller configured to circulate, during operation, a process fluid from the fluid inlet to the fluid outlet; and a mechanical seal. The system includes a mechanical seal cleaning assembly that includes a plate assembly mounted at a seal nose of the mechanical seal; at least one nozzle positioned in the plate assembly and configured to spray a cleaning liquid within the housing towards at least a portion of the mechanical seal; and a cleaning liquid pump fluidly coupled to the at least one nozzle and configured to supply a flow of the cleaning liquid to the at least one nozzle.

In an aspect combinable with the example implementation, the plate assembly includes a base plate including a ring mounted at the seal nose and having a bore configured to receive the shaft; and a cover plate coupled to the base plate and including a ring having a bore configured to receive the shaft.

In another aspect combinable with one, some, or all of the previous aspects, the base plate includes at least one nozzle port configured to at least partially enclose the at least one nozzle, and the cover plate includes a groove that forms a portion of a fluid path for the cleaning liquid from the cleaning liquid pump to the nozzle port.

In another aspect combinable with one, some, or all of the previous aspects, the fluid path includes an internal port formed from the groove to an outlet at the housing; and an external conduit fluidly coupled to the internal port and the cleaning liquid pump.

In another aspect combinable with one, some, or all of the previous aspects, the external conduit is fluidly coupled to the internal port at a check valve.

In another aspect combinable with one, some, or all of the previous aspects, each of the base plate and the cover plate is formed as a split O-ring included of a U-portion and an inverted U-portion.

In another aspect combinable with one, some, or all of the previous aspects, the at least one nozzle includes a spring loaded nozzle that includes a plug, a plug seat, and a spring.

In another aspect combinable with one, some, or all of the previous aspects, the at least one nozzle includes a plurality of nozzles, each of the plurality of nozzles radially spaced around the base plate between 60° and 90°.

Another aspect combinable with one, some, or all of the previous aspects further includes a cleaning liquid reservoir fluidly coupled to the cleaning liquid pump and configured to store a volume of the cleaning liquid.

Another aspect combinable with one, some, or all of the previous aspects further includes a control system communicably coupled to the cleaning liquid pump and configured to perform operations including: identifying a start time of the mechanical seal cleaning assembly prior to a start-up time of the pump; activating the cleaning liquid pump to supply the cleaning liquid from the cleaning liquid reservoir to the one or more nozzles for a time duration sufficient to clean at least a portion of the pump; and deactivating the cleaning liquid pump after expiration of the time duration.

In another aspect combinable with one, some, or all of the previous aspects, the pump includes a wet mechanical seal.

In another example implementation, a method of cleaning at least a portion of a pump includes operating a pump to circulate a process fluid from a fluid inlet, through a housing, and to a fluid outlet of the pump by rotation of at least one impeller on a shaft that extends through the housing; and during non-operation of the pump, cleaning at least a portion of a mechanical seal of the pump with a mechanical seal cleaning assembly by injecting a cleaning liquid from a cleaning liquid pump to a plate assembly mounted at a seal nose of the mechanical seal and coaxial with a centerline of the shaft; and spraying the cleaning liquid from at least one nozzle positioned in the plate assembly within the housing toward the portion of the mechanical seal.

In an aspect combinable with the example implementation, the plate assembly includes a base plate including a ring mounted at the seal nose and having a bore configured to receive the shaft; and a cover plate coupled to the base plate and including a ring having a bore configured to receive the shaft.

In another aspect combinable with one, some, or all of the previous aspects, circulating the cleaning liquid from the cleaning liquid pump to the plate assembly includes circulating the cleaning liquid from the cleaning liquid pump to a groove in the cover plate that forms a portion of a fluid path for the cleaning liquid from the cleaning liquid pump to at least one nozzle port formed in the base plate; and circulating the cleaning liquid in the at least one nozzle port to the at least one nozzle enclosed within the at least one nozzle port.

Another aspect combinable with one, some, or all of the previous aspects further includes circulating the cleaning liquid from the cleaning liquid pump through an external conduit; and circulating the cleaning liquid from the external conduit, through an outlet at the housing, and to an internal port that fluidly connects the groove to the outlet.

Another aspect combinable with one, some, or all of the previous aspects further includes circulating the cleaning liquid through a check valve that fluidly couples the external conduit to the internal port.

In another aspect combinable with one, some, or all of the previous aspects, each of the base plate and the cover plate is formed as a split O-ring included of a U-portion and an inverted U-portion.

In another aspect combinable with one, some, or all of the previous aspects, the at least one nozzle includes a spring loaded nozzle that includes a plug, a plug seat, and a spring.

In another aspect combinable with one, some, or all of the previous aspects, spraying the cleaning liquid from at least one nozzle includes spraying the cleaning liquid from a plurality of nozzles, each of the plurality of nozzles radially spaced around the base plate between 60° and 90°.

Another aspect combinable with one, some, or all of the previous aspects further includes circulating the cleaning liquid from a cleaning liquid reservoir fluidly coupled to the cleaning liquid pump.

Another aspect combinable with one, some, or all of the previous aspects further includes identifying, with a controller communicably coupled to the cleaning liquid pump, a start time of the mechanical seal cleaning assembly prior to a start-up time of the pump; activating, with the controller, the cleaning liquid pump to supply the cleaning liquid from the cleaning liquid reservoir to the one or more nozzles for a time duration sufficient to clean at least a portion of the pump; and deactivating, with the controller, the cleaning liquid pump after expiration of the time duration.

In another aspect combinable with one, some, or all of the previous aspects, the pump includes a wet mechanical seal.

In another example implementation, a pump cleaning assembly includes a ring assembly configured to be mounted at a seal nose coaxial with a shaft center-line of a pump shaft of a centrifugal pump; a plurality of spring-loaded nozzles positioned in the ring assembly and configured to spray a pressurized liquid along the pump shaft within a pump housing of the centrifugal pump; and a liquid pump fluidly coupled to the plurality of spring-loaded nozzles through a tubing assembly.

In an aspect combinable with the example implementation, the ring assembly includes a first ring including a bore configured to receive the pump shaft; and a second ring coupled to the first ring and including a bore configured to receive the pump shaft.

In another aspect combinable with one, some, or all of the previous aspects, the first and second rings are coupled to form an interface that includes a fluid path that fluidly connects the plurality of spring-loaded nozzles with the tubing assembly.

In another aspect combinable with one, some, or all of the previous aspects, the tubing assembly includes a first tubing portion that is configured to extend through the pump housing; a check valve configured to permit one-way flow of the liquid toward the plurality of spring-loaded nozzles; and a second tubing portion configured to fluidly couple to the first tubing portion through the check valve.

Another aspect combinable with one, some, or all of the previous aspects further includes a reservoir configured to fluidly couple to the liquid pump and store a volume of the liquid; and a controller communicably coupled to the liquid pump.

In another aspect combinable with one, some, or all of the previous aspects, the controller is configured to perform operations including activating the liquid pump to supply the liquid from the reservoir to the plurality of spring-loaded nozzles for a specified time duration; and deactivating the liquid pump after expiration of the specified time duration.

Implementations of systems and methods for cleaning one or more pump seal surfaces according to the present disclosure may also include one or more of the following features. For example, implementations according to the present disclosure can directly and actively clean mechanical seal faces of a pump to remove slug and debris. As another example, implementations according to the present disclosure can only be operated as necessary, such as only a few minutes prior to starting the pump and can be stopped just before starting the pump or after a few minutes of start-up. Thus, implementations according to the present disclosure can operate with virtually no energy loss as it does not require continuous operation. Further, implementations according to the present disclosure can provide the capability to clean the mechanical seal faces mating location directly by providing liquid jets or a high-pressure fluid flow using, for example, spring-loaded nozzles. Also, implementations according to the present disclosure can be implemented with almost all types of seal plans as an auxiliary seal flushing or cleaning plan. As another example, implementations according to the present disclosure can also solve issues of seal failures due to a deposit of dust particles at the seal chamber if the operations contain powdered insoluble solids by intermittently flushing the seal chamber with a pressurized cleaning fluid, thereby creating turbulence in the seal chamber to remove the deposited solids.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of a pump system that includes an example implementation of a mechanical seal cleaning assembly according to the present disclosure.

FIG. 2 is a schematic diagram of a more detailed view of the pump system that includes the mechanical seal cleaning assembly of FIG. 1.

FIGS. 3A-3D are schematic diagrams of portions of an example implementation of a mechanical seal cleaning assembly according to the present disclosure.

FIG. 4 is a schematic diagram of a nozzle of an example implementation of a mechanical seal cleaning assembly according to the present disclosure.

FIG. 5 is a schematic diagram of a pump system that includes another example implementation of a mechanical seal cleaning assembly according to the present disclosure.

FIG. 6 is a schematic diagram of portions of the mechanical seal cleaning assembly of FIG. 5.

FIG. 7 shows a schematic drawing of a control system that can be used to control one or more operations associated with a mechanical seal cleaning assembly described in the present disclosure.

### DETAILED DESCRIPTION

The present disclosure describes example implementations of a mechanical seal cleaning assembly that can be installed and used in pumps, such as centrifugal pumps, screw pumps, progressive cavity pumps, or even vacuum-ring pumps or compressors (for example, which include a wet mechanical seal). In some aspects, implementations of a mechanical seal cleaning assembly according to the present disclosure can be installed and used in pumps that circulate corrosive or dirty fluids, such as fluids with particulates or dirt that can, without cleaning, cause damage or failure of a mechanical seal within the pump.

For example, implementations of a mechanical seal cleaning assembly according to the present disclosure can be used in pumps (with “dirty” service) to clean and de-clog deposits to reduce or avoid pump seal failures due to dirt accumulation. In example implementations, a mechanical seal cleaning assembly can induce a backwash flow of a cleaning liquid (for example, water, thinner, diesel, or otherwise) through a plate (or disk) assembly positioned within the pump seal housing (chamber) at or near a front section (for example, at a seal nose) of a mechanical seal inside the seal chamber of a pump. The cleaning liquid can be injected through a nozzle manifold (for example, of one or more nozzles) mounted within the plate assembly so that the cleaning liquid is sprayed or introduced (for example, as a pressurized cleaning liquid) to the mechanical seal faces mating location.

Thus, in example pump operations, prior to pump startup, the cleaning liquid can be injected by the mechanical seal cleaning assembly (for example, from or through an injection pump that is manually or automatically operated) to the seal chamber to clean seal faces of the mechanical seal of the pump. Subsequent to such a cleaning operation, the mechanical seal can be relatively freed (or have a reduced amount) of dirt or other debris, thereby allowing proper operation of the mechanical seal during pump operation.

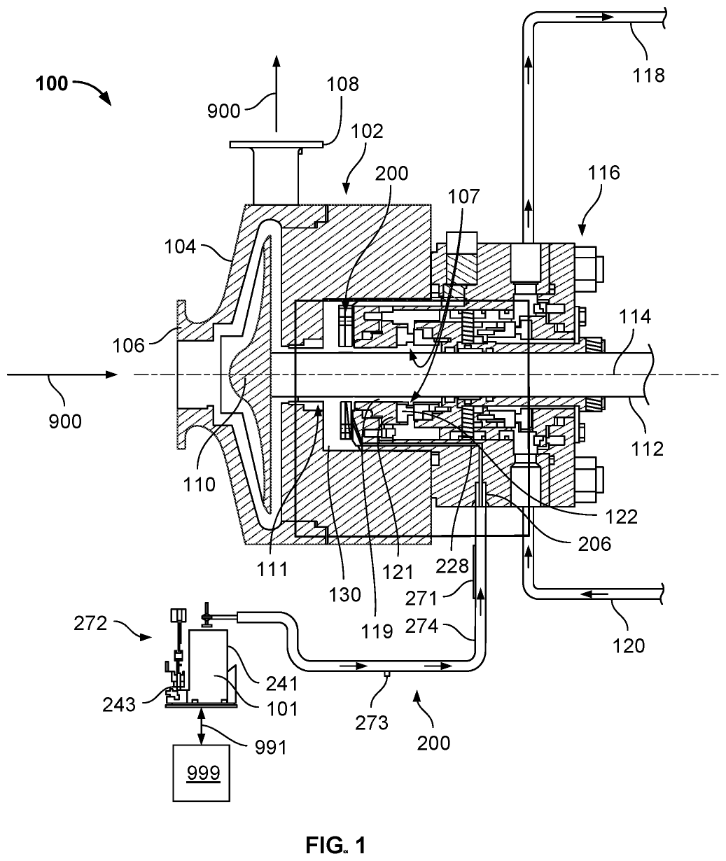

FIG. 1 is a schematic diagram of a pump system 100 that includes an example implementation of a mechanical seal cleaning assembly 200 according to the present disclosure. In this example implementation, the pump system 100 includes a pump 102 (a portion of which is shown in FIG. 1) that includes a housing 104 that defines a seal chamber 130 with a fluid inlet 106 and a fluid outlet 108. In this example, the pump 102 comprises a centrifugal pump 102 that includes one or more impellers 110 mounted on a shaft 112 that extends along an axial centerline 114, through the seal chamber 130, and to a motor (or any other prime mover, not shown). Pump 102, generally, operates by rotating the one or more impellers 110 (or rotors) along with the pump shaft 112 (driven by an electric motor or other prime mover) to circulate a process fluid 900 from the inlet 106 to the outlet 108 (and to, for example, portions of a piping system, not shown).

As shown in this example of FIG. 1, the pump 102 includes a mechanical seal 116 that operates, for example, to prevent leakage of the process fluid 900 (which can be corrosive and/or have adverse effect on environment and other equipment) to atmosphere or from reaching portions of the pump 102 (or an electric motor hermetically sealed with the pump 102) through a gap between the seal faces, as there always needs to be fine gap of few microns between the relatively rotating faces, static face 121 and rotating face 122 to ensure proper lubrication of the seal faces. A lubricating (or flushing) fluid is supplied through seal inlet 120 to lubricate one or more portions of the mechanical seal 116 and is circulated out of the mechanical seal 116 through a seal outlet 118. In FIG. 1, the front part of mechanical seal adjacent to the shaft 112 and facing the pump impellers 110 is called a seal nose (also called seal nose 107 herein).

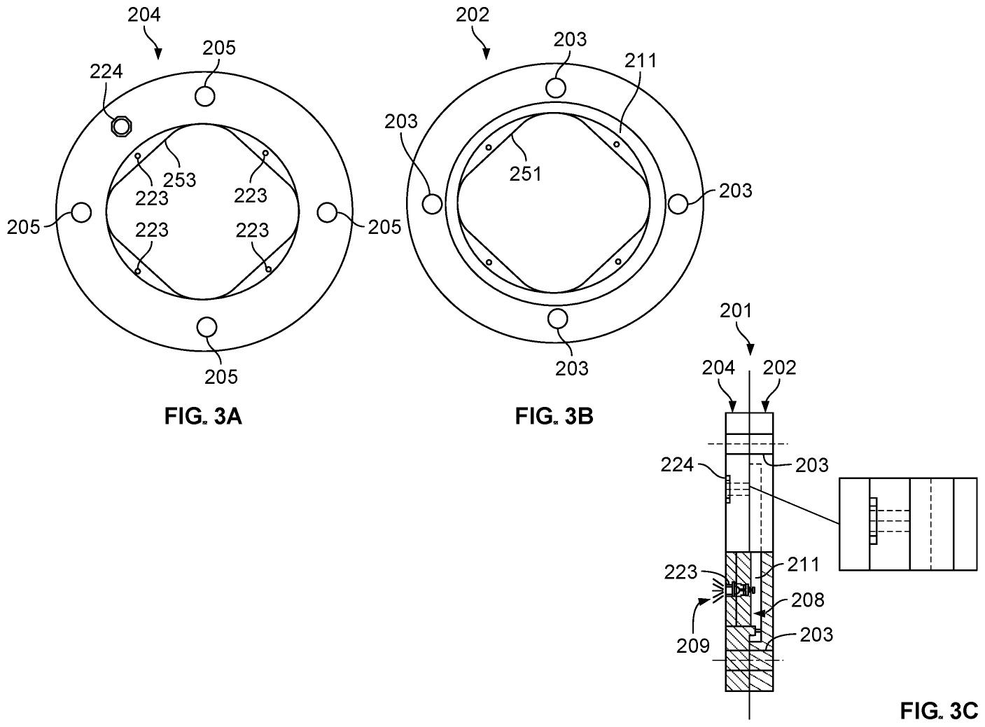

In this example implementation of the pumping system 100, the mechanical seal cleaning assembly 200 includes a plate assembly 201 that is mounted at (for example, by slipping or installing over) the seal nose 107. As shown in this example, the plate assembly 201 (explained in more detail herein) is positioned at the seal nose 107 of the mechanical seal 116. The plate assembly 201 is fluidly coupled to a cleaning fluid pump/source 272 through an external fluid conduit 274, one or more check valves 206, and an internal port 228 and paths sealed by O-rings at slot 224 (as shown in FIG. 3C) to avoid leakage at interface locations of two pump parts. The cleaning fluid pump/source 272 can include, for example, a reservoir 241 for a cleaning fluid 101, as well as a pump 243 operable to inject the cleaning fluid 101 through the external fluid conduit 274, the one or more check valves 206, and the internal port 228 (during a pump cleaning operation by the mechanical seal cleaning assembly 200). Although shown as integrally coupled, the reservoir 241 and the pump 243 can be separate components as well.

In some aspects, the pump 243 can be selected (for example, by flow rate and head) so as to inject a pressurized flow of the cleaning liquid 101 through the external fluid conduit 274, the one or more check valves 206, and the internal port 228 and to the plate assembly 201, where the liquid 101 is sprayed into the gap 119 to clean the mating faces portion 107 (and/or other parts) of the mechanical seal 116. In some aspects, the pump 243 can be manually operated; alternatively, the pump 243 can be a motor driven positive displacement pump. Optionally, the pump 243 can include a pneumatic closure valve.

In example implementations, the mechanical seal cleaning assembly 200 can (optionally) include a control system 999. Control system (or controller) 999 can be, for example, a microprocessor-based PLC controller, a pneumatic or hydraulic controller, electromechanical controller, or mechanical controller. Control system 999 can be programmed or operated (for example, by a human operator) to control the operations of the cleaning fluid pump/source 272 to inject the cleaning liquid 101 to the plate assembly 201 of the mechanical seal cleaning assembly 200.

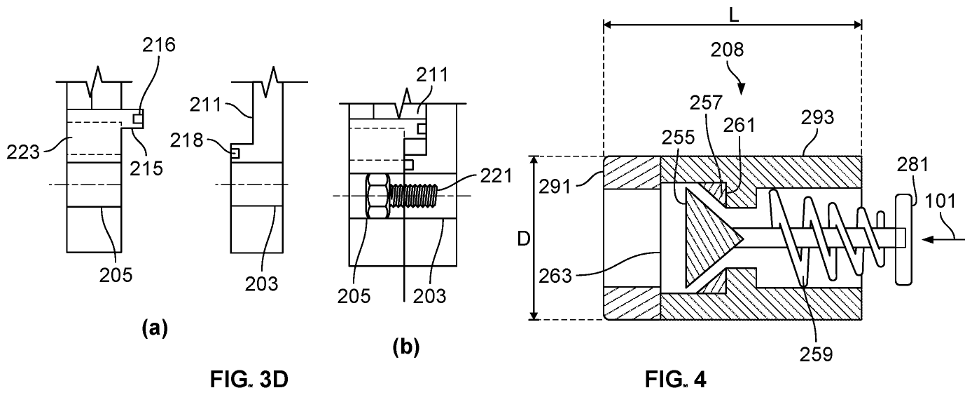

For example, control system 999 can be programmed to send control commands 991 to (and/or receive operational feedback 991 from) the cleaning fluid pump/source 272 to activate the mechanical seal cleaning assembly 200 to clean the pump 102 prior to pump operation (for example, as part of a start-up procedure of the pump system 100). The control system 999 can operate the cleaning fluid pump/source 272 to supply the nozzle(s) 208 (as shown in FIG. 4) with the cleaning liquid 101 for a time duration sufficient to clean at least a portion (for example a portion of a mechanical seal) of the pump 102. The control system 999 can stop operation of the cleaning fluid pump/source 272 to stop the supply of the cleaning liquid 101 to the nozzle(s) 208 after expiration of the sufficient time duration.

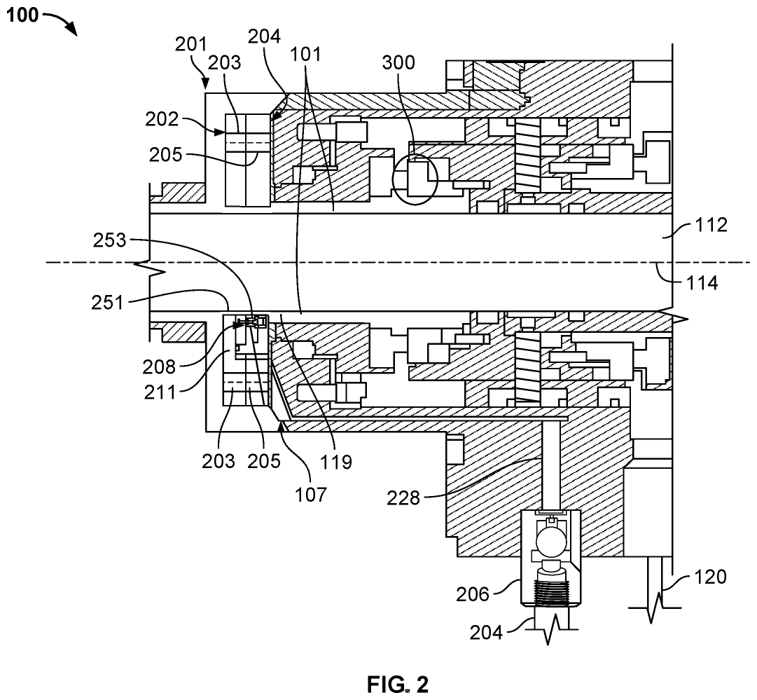

Turning to FIG. 2, this figure shows a schematic diagram of a more detailed view of the pump system 100 that includes the mechanical seal cleaning assembly 200 of FIG. 1. As shown in this figure, the plate assembly 201 includes a cover plate 202 coupled (for example, fastened) to a base plate 204. In combination, the base plate 204 and cover plate 202 are ring shaped plates that include respective bores 253 and 251 through which the shaft 112 is inserted so that the center of the plate assembly 201 (in other words, plates 202 and 204) is aligned with the center line 114 of the shaft 112 without touching the shaft 112.

As shown in this example, when mounted at or on the seal nose 107, the base plate 204 and cover plate 202 are aligned such that outer circumferential edges of the plates 202 and 204 are aligned, thereby also aligning respective fastener holes 203 (in cover plate 202) with fastener holes 205 (in base plate 204). Mechanical fasteners (shown in FIG. 3D) can be installed through the respective holes 203 and 205 to fasten and align the cover plate 202 with the base plate 204 (for example, prior or subsequent to installation on the shaft 112).

In example aspects, the base plate 204 can be installed in contact with a seal nose (i.e., the nose portion 107) and also include one or more nozzles 208 installed as a nozzle manifold for delivering the cleaning fluid 101 to the seal faces location 107 between static face 121 and rotating face 122 (as explained more fully herein). In some aspects, the base plate 204 can be about 2-3 mm thick and be made from a corrosion and wear resistant material, such as 304 stainless steel. However, the material of the base plate 204 can also depend on a composition of the process fluid 900. For example, use of 304 stainless steel or other similar material may be suitable when the process fluid 900 is free of hydrogen sulfide or other corrosive substance. If the process fluid 900 is a sour fluid, the material can be high speed steel or Inconel compatible for corrosive fluid.

As shown in FIG. 2, there can be at least one nozzle 208 installed in the plate assembly 201. However, there can also be multiple nozzles 208 installed in radial increments within the plate assembly 201 (as explained more fully here). Each nozzle 208 can be contained in the base plate 204 and be contained therein upon installation of the cover plate 202 with the base plate 204 to form the plate assembly 201.

Turning briefly to FIG. 4, this figure shows a schematic diagram of an example implementation of the nozzle 208. As shown in this example, the nozzle 208 includes a body 293 in which a plug 255 is positioned such that a plug stopper 281 extends from an open end of the body 293. A plug seat 257 is installed or formed on a shoulder 261 of the body 293 so that the plug 255 can seal a flow-path 263 through the nozzle 208 (to stop a flow of the cleaning liquid 101 through the nozzle 208). The plug 255 and plug seat 257 is retained in the body 293 with a holder lock 291 that can be installed (for example, by threaded joint) onto the body 293 once the plug 255 is installed in the flow-path 263. A spring 259 is installed along the stem of the plug 255 within the body 293.

Thus, this example nozzle 208 comprises a spring-loaded nozzle that can enhance velocity of a jet of the cleaning liquid 101 as it passes through the flow-path 263 (during a cleaning operation of the mechanical seal cleaning assembly 200). This is due to a minimum force (pressure) of the cleaning liquid 101 to push the plug 255 away from the plug seat 257 and open the flow-path 263 to a flow of the cleaning liquid 101. This pressure needed to generate a jet of cleaning liquid 101 from the nozzle 208 to clean deposits at a targeted location in the pump 102. Also, the spring-loaded nozzle can act as a check valve to avoid debris and process fluid 900 from entering into the flow-path 263 of the cleaning liquid 101. As soon as the pressure from cleaning liquid 101 is released, the spring 259 acts to seal the plug 255 against the plug seat 257 to stop a flow of the cleaning liquid 101 and seal against entry of the process fluid 900; this can be desirable as the nozzle 208 may be easily clogged by debris within the process fluid 900. In some aspects, each nozzle 208 can be about 4-5 mm in length, L, and 4-5 mm in diameter, D.

In example aspects, the cover plate 202 is positioned to act as a cover for closing a cleaning liquid distribution channel formed by coupling of the cover plate 202 with the base plate 204 (and is fluidly coupled to internal port 228). In some aspects, the cover plate 202 can include an O-Ring of material compatible with the process fluid 900 (for example, inserted within a groove to seal the O-ring against the base plate 204). The O-ring can seal the pressurized cleaning liquid 101 in the plate assembly 201 (as explained more fully with reference to FIG. 3D). In some aspects, the cover plate 202 can be about 2-3 mm thick and be made from a corrosion and wear resistant material, such as 304 stainless steel. However, the material of the cover plate 202 can also depend on a composition of the process fluid 900. For example, use of 304 stainless steel or other similar material may be suitable when the process fluid 900 is free of hydrogen sulfide or other corrosive substance. If the process fluid 900 is a sour fluid, the material can be high speed steel or Inconel compatible with sour service.

As shown in this figure, the internal port 228, which fluidly connects external conduit 274 (and the cleaning liquid 101) with the plate assembly 201 is formed through at least a portion of the housing 104 of the pump 102. The internal port 228, in some aspects, can be a fluid path-way drilled through a gland-plate, pump casing/stuffing box, etc. of the pump 102 depending on the seal design, arrangement, and the orientation of the faces. In some aspects, the internal port 228 can be formed so as to avoid being routed through casted casing parts or brittle material of the housing 104.

In example implementations, such as due to design constraints, the internal port 228 (or ports 228) can be formed through the casted parts; in such examples, the internal port 228 can be tubing (for example, steel or other rigid tubing) that is extruded or pushed through holes in the casted parts. Thus, any pressure in the internal port 228 generated by the cleaning liquid 101 flowing therethrough can be exerted to the tubing instead of the casted material (leading to casing cracks/failures) so as to avoid or reduce any shear stress created in the casting material of the housing 104.

As shown in FIG. 1 and FIG. 2, one or more valves 206 can be installed in the external conduit 274 (or, for instance, between the external conduit 274 and internal port 228). In some aspects, the valve 206 can be a check valve, such as a ball check valve. The check valve 206 can prevent, for instance, process fluid 900 from circulating or leaking into the external conduit 274. If the valve 206 was not a check valve, there are chances of process fluid 900 entering the internal port 228, external conduit 274, or both (or even being released to the atmosphere). In combination, therefore, the nozzles 208 and valve 206 act as two independent check valves to ensure that there is little to no process fluid 900 in the internal port 228 or external conduit 274. In addition, in some aspects (as shown in FIG. 1), a vent 271 and drain 273 can be formed or installed in the external conduit 274 so that gases or vapor in cleaning liquid 101 can be removed prior to or after operation of the mechanical seal cleaning assembly 200 (or also to relieve pressure in the fluid system of the mechanical seal cleaning assembly 200).

Turning now to FIGS. 3A-3D, these figures are schematic diagrams of portions of an example implementation of a mechanical seal cleaning assembly according to the present disclosure. Specifically, these figures show different views and portions of the plate assembly 201. FIG. 3A shows a front view of the base plate 204. FIG. 3B shows a front view of the cover plate 202. FIG. 3C shows a side view of the plate assembly 201 with the base plate 204 coupled to the cover plate 202. FIG. 3D shows a view (a) of portions of the base plate 204 and cover plate 202 prior to coupling and a view (b) that shows the portions of the base plate 204 and cover plate 202 after coupling together.

As shown in FIGS. 3A and 3B, base plate 204 includes holes 205 that align with holes 203 in cover plate 202 when aligned as shown in FIG. 3C. Fasteners 221 can be installed through the holes 205 and 203 to connect the base plate 204 with the cover plate 202 to form the plate assembly 201. Nozzle ports 223 are formed in the base plate 204 to hold nozzles 208 therein. As shown in this example, there are four nozzle ports 223 formed at or about 90° apart around a circumference of the base plate 204. However, more or fewer nozzle ports 223 (to hold more or fewer nozzles 208) can be implemented in the base plate 204, for example, based on a desired volumetric flow rate of the cleaning fluid 101 to be sprayed (as spray 209) through the nozzles 208 to clean the seal faces mating location 107, between the static face 121 and rotating face 122 of the mechanical seal 116. Furthermore, the nozzle ports 223 can be radially spaced at distance other than 90° as desired.

In some aspects, each nozzle 208 can cover approximately 1 inch of periphery of the mating faces portion 107. Considering that some of the nozzles 208 might get clogged or malfunction with operation or time, a 33% contingency can be considered and a number of nozzles 208 needed for installation can be calculated according to a diameter of the shaft 112. For example, for a shaft diameter of 1 inch, three nozzles 208 can be sufficient and, to account for the 33% contingency, four nozzles 208 can be installed 90° apart. For a shaft of 1.5 inches, six nozzles 208 placed 60° apart can be sufficient. Other radial spacings are also possible (for example, depending on the pump shaft size) and contemplated by the present disclosure. The number of nozzles 208 can also be determined on the basis of site experience and a nature of the process fluid 900.

As shown in the example implementation of the cover plate 202 in FIG. 3B, a groove 211 is formed in a face of the cover plate 202 that interfaces with the base plate 204. The groove 211, as shown in FIG. 3C, interfaces with the nozzle port(s) 223 to fluidly couple (when the plate assembly 201 is assembled and installed in the pump 102) with the nozzles 208 and with the internal port 228. Thus, cleaning fluid 101 that is circulated through the internal port 228 is circulated to the nozzle(s) 208 from groove 211 enclosed by the base plate 204.

As shown in the example of view (a) of FIG. 3D, the base plate 204 includes a shoulder 215 into which an O-ring or gasket 216 is installed. Likewise, the cover plate 202 includes an O-ring or gasket 218 that is installed in the cover plate 202 adjacent the groove 211. When the cover plate 202 is mated with the base plate 204 (as shown in view (b)), the gaskets 216 and 218 fluidly seal an interface between the two plates, thereby preventing or reducing a leakage of cleaning liquid 101 from the groove 211, or intrusion of process fluid 900 into the groove 211. In some aspects, the O-rings 216 and 218 may be formed of Viton or PTFE or any O-ring material depending on the process fluid. Alternatively, if the process fluid 900 is sour, the material can be PTFE or Perfluoro elastomer.

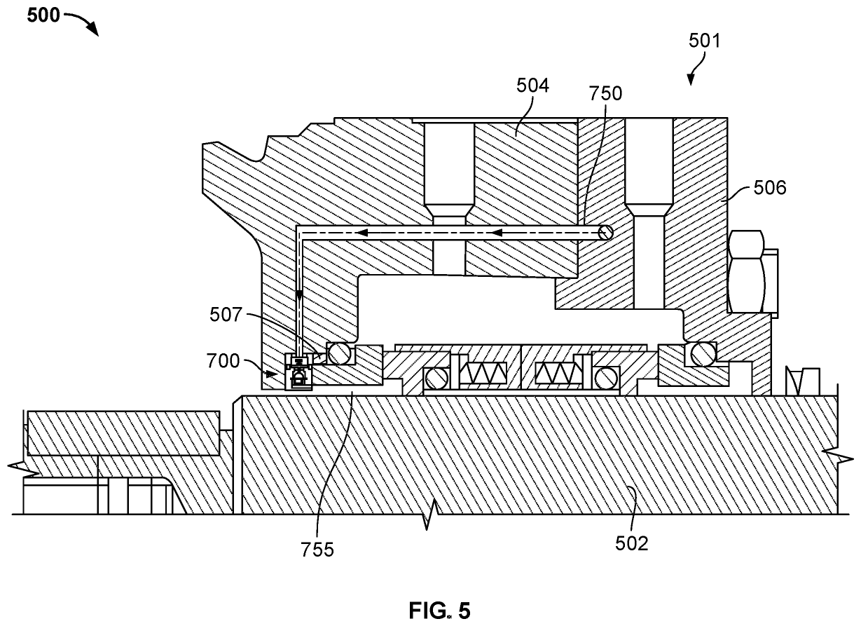

FIG. 5 is a schematic diagram of a pump system 500 that includes another example implementation of a mechanical seal cleaning assembly according to the present disclosure. Pump system 500 can include an example implementation of mechanical seal cleaning assembly 700 that operates largely if not identically similar to the mechanical seal cleaning assembly 700. In this figure, as simplified diagram of the pump system 500 includes a shaft 502 of a pump 501, a pump seal stuffing box 504 of the pump 501, and a seal gland 506 of the pump 501. In this example, the pump 501 may have no seal cartridge, such that a cleaning liquid 755 from the mechanical seal cleaning assembly 700 can be routed from seal gland 506 through the pump seal stuffing box 504 to end of the seal. The cleaning assembly 700 can be placed towards the process end of the seal assembly along with a spacer ring 507.

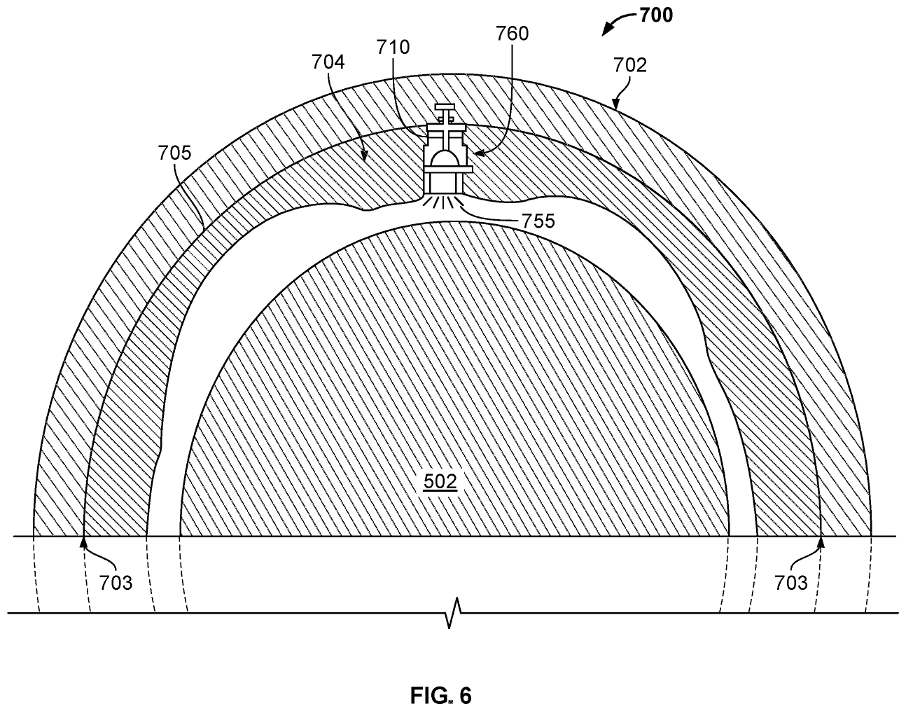

In this example, and with reference to FIG. 6 as well, the mechanical seal cleaning assembly 700 is fed with the cleaning liquid 755 through a tubing 750 (which can connect to a pump/reservoir with one or more valves, vents, and/or drains as described with reference to the mechanical seal cleaning assembly 200). The mechanical seal cleaning assembly 700 includes a base ring 704 and a cover ring 702. One or more nozzles 710 (which can be similar or identical to nozzles 208) are positioned in nozzle ports 760 in the base ring 704 as shown in FIG. 6. In this example, each of the base ring 704 and cover ring 702 are formed as split rings of inverted-U and U shapes, respectively (which join to form a ring). Thus, when joined, the inverted U and U shaped half-rings combine to make an O-cross section channel for each of the base ring 704 and cover ring 702. Interfaces of the split rings can be sealed by O-rings 703 at both ends.

In this example implementation, the cleaning liquid 755 can enter the inverted-U of the cover ring 702 at a periphery and will be circulated in the O-cross section made by joining both the split rings. Spring-loaded nozzles 710 installed at the U-cross section ring release the cleaning liquid 755 into seal chamber for cleaning. The U-section ring can have fluid release ports oriented in an axial direction (parallel to a length of the shaft 502) so as to release the cleaning liquid towards seal mating faces of the pump 501.

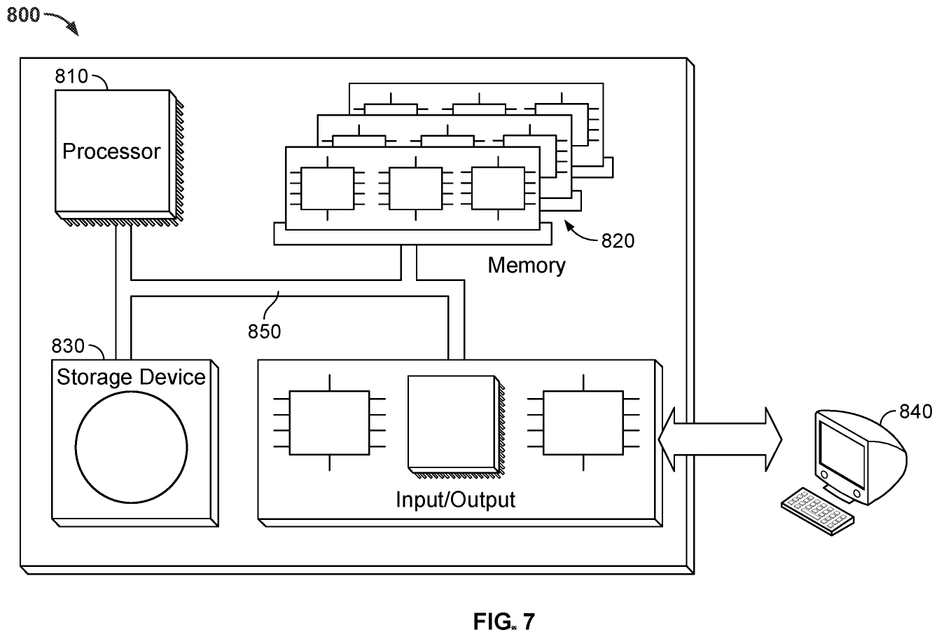

FIG. 7 shows a schematic drawing of a control system 800 that can be used to implement one or more processes described in the present disclosure. Some or all of the example control system 800 can be implemented as the control system (or controller) 999 as shown and described in FIG. 1. The control system, generally, can be any generic flow control system that has capability to start the cleaning fluid pump 243 when a command for running the main pump is given from a Plant Distributed Control System (DCS) or manually at site. For example, the control system can run the cleaning fluid pump 243 for few minutes like (for example, 5 minutes) before running the main pump. The control system can have the capacity to be bypassed and run the main process pump 100 in case of emergency.

In some aspects, the control system 800 includes cloud-based system and/or service, alone or in combination with other portions of the example control system 800. The control system (or controller) 800 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output device 840. Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the control system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, a tape device, flash memory, a solid state device (SSD), or a combination thereof.

The input/output device 840 provides input/output operations for the controller 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A pump system, comprising:
a pump that comprises:
a housing that comprises a fluid inlet and a fluid outlet;
a shaft that extends through the housing and is coupled to at least one impeller configured to circulate, during operation, a process fluid from the fluid inlet to the fluid outlet; and
a mechanical seal; and
a mechanical seal cleaning assembly, comprising:
a plate assembly mounted at a seal nose of the mechanical seal;
at least one nozzle positioned in the plate assembly and configured to spray a cleaning liquid within the housing toward at least a portion of the mechanical seal; and
a cleaning liquid pump fluidly coupled to the at least one nozzle and configured to supply a flow of the cleaning liquid to the at least one nozzle.

2. The pump system of claim 1, wherein the plate assembly comprises:
a base plate comprising a ring mounted at the seal nose and having a bore configured to receive the shaft; and
a cover plate coupled to the base plate and comprising a ring having a bore configured to receive the shaft.

3. The pump system of claim 2, wherein the base plate comprises at least one nozzle port configured to at least partially enclose the at least one nozzle, and the cover plate comprises a groove that forms a portion of a fluid path for the cleaning liquid from the cleaning liquid pump to the nozzle port.

4. The pump system of claim 3, wherein the fluid path comprises:
an internal port formed from the groove to an outlet at the housing; and
an external conduit fluidly coupled to the internal port and the cleaning liquid pump.

5. The pump system of claim 4, wherein the external conduit is fluidly coupled to the internal port at a check valve.

6. The pump system of claim 2, wherein each of the base plate and the cover plate is formed as a split O-ring comprised of a U-portion and an inverted U-portion.

7. The pump system of claim 1, wherein the at least one nozzle comprises a spring loaded nozzle that comprises a plug, a plug seat, and a spring.

8. The pump system of claim 1, wherein the at least one nozzle comprises a plurality of nozzles, each of the plurality of nozzles radially spaced around the base plate between 60° and 90°.

9. The pump system of claim 1, comprising a cleaning liquid reservoir fluidly coupled to the cleaning liquid pump and configured to store a volume of the cleaning liquid.

10. The pump system of claim 1, comprising a control system communicably coupled to the cleaning liquid pump and configured to perform operations, comprising:
identifying a start time of the mechanical seal cleaning assembly prior to a start-up time of the pump;
activating the cleaning liquid pump to supply the cleaning liquid from the cleaning liquid reservoir to the one or more nozzles for a time duration sufficient to clean at least a portion of the pump; and
deactivating the cleaning liquid pump after expiration of the time duration.

11. The pump system of claim 1, wherein the pump comprises a wet mechanical seal.

12. A method of cleaning at least a portion of a pump, comprising:
operating a pump to circulate a process fluid from a fluid inlet, through a housing, and to a fluid outlet of the pump by rotation of at least one impeller on a shaft that extends through the housing; and
during non-operation of the pump, cleaning at least a portion of a mechanical seal of the pump with a mechanical seal cleaning assembly, the cleaning comprising:
injecting a cleaning liquid from a cleaning liquid pump to a plate assembly mounted at a seal nose of the mechanical seal and coaxial with a centerline of the shaft; and
spraying the cleaning liquid from at least one nozzle positioned in the plate assembly within the housing toward the portion of the mechanical seal.

13. The method of claim 12, wherein the plate assembly comprises:
a base plate comprising a ring mounted at the seal nose and having a bore configured to receive the shaft; and
a cover plate coupled to the base plate and comprising a ring having a bore configured to receive the shaft.

14. The method of claim 13, wherein circulating the cleaning liquid from the cleaning liquid pump to the plate assembly comprises:
circulating the cleaning liquid from the cleaning liquid pump to a groove in the cover plate that forms a portion of a fluid path for the cleaning liquid from the cleaning liquid pump to at least one nozzle port formed in the base plate; and
circulating the cleaning liquid in the at least one nozzle port to the at least one nozzle enclosed within the at least one nozzle port.

15. The method of claim 14, comprising:
circulating the cleaning liquid from the cleaning liquid pump through an external conduit; and
circulating the cleaning liquid from the external conduit, through an outlet at the housing, and to an internal port that fluidly connects the groove to the outlet.

16. The method of claim 15, comprising circulating the cleaning liquid through a check valve that fluidly couples the external conduit to the internal port.

17. The method of claim 13, wherein each of the base plate and the cover plate is formed as a split O-ring comprised of a U-portion and an inverted U-portion.

18. The method of claim 12, wherein the at least one nozzle comprises a spring loaded nozzle that comprises a plug, a plug seat, and a spring.

19. The method of claim 12, wherein spraying the cleaning liquid from at least one nozzle comprises spraying the cleaning liquid from a plurality of nozzles, each of the plurality of nozzles radially spaced around the base plate between 60° and 90°.

20. The method of claim 12, comprising circulating the cleaning liquid from a cleaning liquid reservoir fluidly coupled to the cleaning liquid pump.

21. The method of claim 12, comprising:
identifying, with a controller communicably coupled to the cleaning liquid pump, a start time of the mechanical seal cleaning assembly prior to a start-up time of the pump;
activating, with the controller, the cleaning liquid pump to supply the cleaning liquid from the cleaning liquid reservoir to the one or more nozzles for a time duration sufficient to clean at least a portion of the pump; and
deactivating, with the controller, the cleaning liquid pump after expiration of the time duration.

22. The method of claim 12, wherein the pump comprises a wet mechanical seal.

23. A pump cleaning assembly, comprising:
a ring assembly configured to be mounted at a seal nose coaxial with a shaft center-line of a pump shaft of a centrifugal pump;
a plurality of spring-loaded nozzles positioned in the ring assembly and configured to spray a pressurized liquid along the pump shaft within a pump housing of the centrifugal pump; and
a liquid pump fluidly coupled to the plurality of spring-loaded nozzles through a tubing assembly.

24. The pump cleaning assembly of claim 23, wherein the ring assembly comprises:
a first ring comprising a bore configured to receive the pump shaft; and
a second ring coupled to the first ring and comprising a bore configured to receive the pump shaft.

25. The pump cleaning assembly of claim 24, wherein the first and second rings are coupled to form an interface that comprises a fluid path that fluidly connects the plurality of spring-loaded nozzles with the tubing assembly.

26. The pump cleaning assembly of claim 25, wherein the tubing assembly comprises:
a first tubing portion that is configured to extend through the pump housing;
a check valve configured to permit one-way flow of the liquid toward the plurality of spring-loaded nozzles; and
a second tubing portion configured to fluidly couple to the first tubing portion through the check valve.

27. The pump cleaning assembly of claim 23, comprising:
a reservoir configured to fluidly couple to the liquid pump and store a volume of the liquid; and
a controller communicably coupled to the liquid pump and configured to perform operations, comprising:
activating the liquid pump to supply the liquid from the reservoir to the plurality of spring-loaded nozzles for a specified time duration; and
deactivating the liquid pump after expiration of the specified time duration.
